(19) United States
(12) Patent Application Publication
(10) Pub. No.: US 2008/0220883 A1
(43) Pub. Date: Sep. 11, 2008

(54) LOW NOISE AND VIBRATION FLEXIBLE SHAFT ASSEMBLY

(76) Inventor: Tat M. Yuen, Old Bridge, NJ (US)

Correspondence Address: ARTHUR L. LESSLER, 540 OLD BRIDGE TURNPIKE, SOUTH RIVER, NJ, 08882, US

(21) Appl. No.: 12/040,870

(22) Filed: Mar. 1, 2008

Related U.S. Application Data
(60) Provisional application No. 60/894,021, filed on Mar. 9, 2007.

(51) Int. Cl. F16C 1/02

(52) U.S. Cl. 464/52

(57) ABSTRACT

A rotatable torque transmitting flexible shaft assembly having a casing surrounding the shaft and a sheath of felt wrapped around and bonded to the shaft either throughout its length or at spaced intervals, to reduce transmission of noise and vibration between the shaft and the casing. Alternatively the felt sheath may be secured to the interior surface of the casing.

### CROSS-REFERENCE TO RELATED APPLICATION

This application claims the benefit of U.S. Provisional Application Ser. No. 60/894,021 filed Mar. 9, 2007 and entitled Low Noise and Vibration Flexible Shaft Assembly.

### BACKGROUND OF THE INVENTION

The present invention relates to a rotatable wire wound flexible shaft assembly for transmitting torque with reduced noise and vibration.

Wire wound flexible shafts typically comprise a central or mandrel wire on which are successively helically wound one or more layers of wire. See, for example, U.S. Pat. Nos. 571,869 to Stow; 1,905,197 to Webb; 1,952,301 to Webb; 2,142,497 to Clendenin; 2,401,100 to Pile; 2,875,597 to Neubauer; 3,274,846 to Forster; 4,112,708 to Fukuda; and 5,288,270 to Ishikawa.

In torque transmitting flexible shaft assemblies of the type wherein a generally cylindrical casing surrounds the rotating shaft, the forces generated cause the shaft to intermittently or continuously contact the interior surface of the casing, resulting in generation of objectionable noise and vibration.

Prior art efforts to reduce such noise and vibration include applying flocked yarn or flock fibers, grease, or heat shrink tubing such as polytetrafluoroethylene to the shaft. Such constructions have various disadvantages such as significant manufacturing expense, fabrication difficulty, limited durability, limited useful life, and/or a performance level less than that desired.

U.S. Pat. No. 6,878,873 to Fryberger, Jr. et al. shows a coiled damping sleeve using felt as the vibration absorbing material for surrounding and isolating vibrations of stationary elongated structures which are prone to vibration, such as automotive wiring harnesses, fluid conduits such as brake lines and fuel lines, and optical fiber bundles. The structure shown therein, however, is not suitable for use with a rotatable elongated member such as a torque transmitting flexible shaft.

U.S. Pat. No. 4,780,002 to Krause shows a felt ring disposed between two longitudinally spaced bearings. The ring is saturated with lubricant which serves as a supply source for the bearings. That arrangement is not suited for use in damping noise and vibration of a rotating flexible shaft.

Accordingly, an object of the present invention is to provide a reduced noise and vibration flexible shaft assembly which can readily be manufactured at reasonable cost.

### SUMMARY OF THE INVENTION

According to the invention, a flexible shaft assembly has a torque transmitting flexible shaft, a coaxial casing surrounding a major portion of the shaft, and felt material (or another material with similar mechanical characteristics) in the form of a coaxial sheath between the shaft and the casing, the sheath being secured to either the outer surface of the shaft or the inner surface of the casing. The felt may extend substantially continuously along the length of the shaft and casing or be in the form of separate sections spaced apart longitudinally along that length.

### IN THE DRAWING

FIG. 1 is an isometric view of a flexible shaft assembly according to a first embodiment of the invention.

FIG. 2A is a cross-sectional view of the assembly shown in FIG. 1.

FIG. 2B is a front elevation view of the assembly shown in FIG. 1.

FIG. 3 is a cross-sectional view of a flexible shaft assembly according to a second embodiment of the invention.

### DETAILED DESCRIPTION

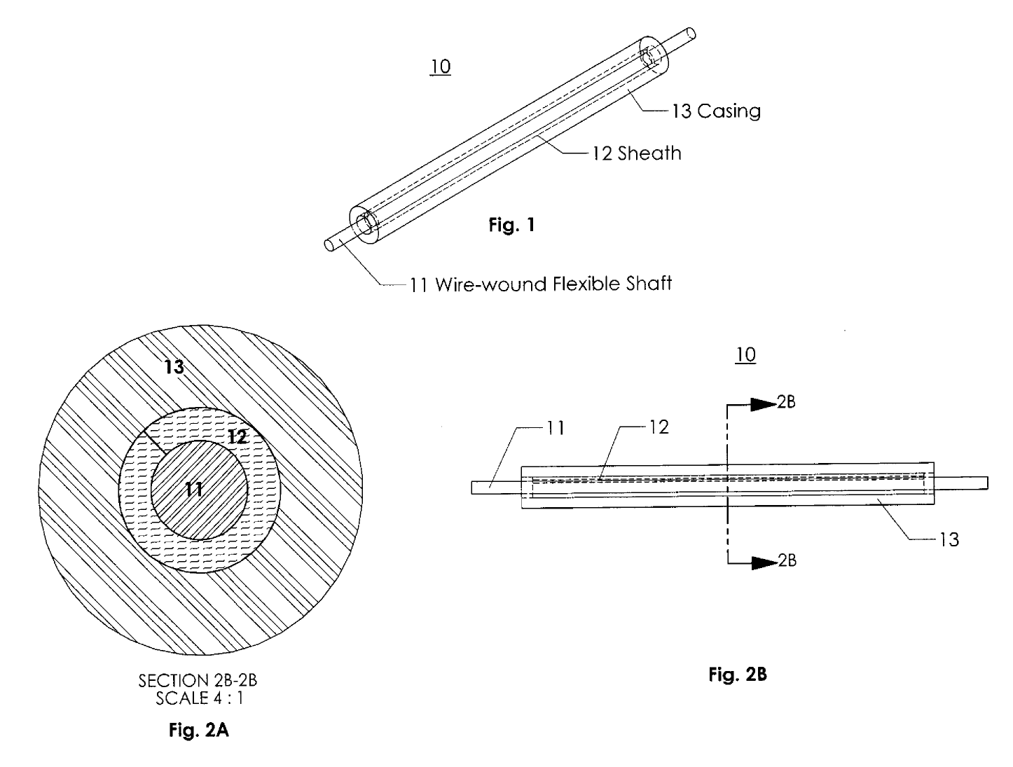

As seen in FIGS. 1, 2A and 2B, a wire wound flexible shaft assembly 10 has a cylindrical wire wound flexible shaft 11 on the surface of which is wrapped one or more layers of felt to form a sheath 12, the sheath 12 being glued or otherwise adherent to the shaft 11. A casing 13 closely surrounds the shaft 11 and felt sheath 12, with no space or a relatively small space between the outer surface of the sheath and the inner surface of the casing.

The sheath 12 may, for example, be made of a strip of pressure-sensitive-adhesive-backed 1 mm. thick acrylic felt wrapped longitudinally around a flexible wound wire shaft. Alternatively, a material having similar mechanical characteristics may be used to form the sheath 12. Such a material may, for example, comprise a velour or velvet fabric or any other type of wrapped, molded or over-molded material that is soft and compliant and which serves the same function as the felt material described herein.

The felt sheath 12, which functions as a vibration and noise damping member, may be of any type of felt material and in any shape suitable for a particular application. It may be backed with pressure sensitive adhesive or glued to the shaft 11. Any edges of the sheath 12 may be finished by being fused or staked by the application of heat and pressure.

While the felt sheath 12 is shown as being applied to the shaft 11 in FIGS. 1 through 2B, it may alternatively be applied and secured to the inside surface of the casing 13.

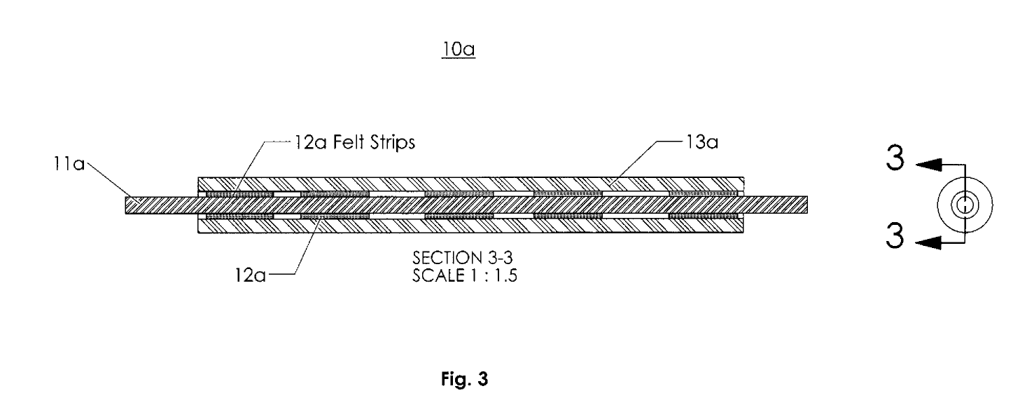

In another embodiment shown in FIG. 3, in which elements corresponding to those of FIGS. 1 through 2B are given the same reference numerals followed by the letter “a”, felt strips 12a are wrapped around the shaft 11a at spaced intervals along the length of the shaft, so that the wrapped felt strips act as sleeves or bushings.

The ends of the shafts 11, 11a are typically formed square in cross-section to interface with driving and driven components.

In the construction of FIGS. 1 through 2B a single rectangular strip of felt is longitudinally wrapped around and affixed to a flexible shaft 11 to form the sheath 12. The felt sheathed shaft is then inserted inside a tubular casing 13 to form the felted shaft assembly.

In the construction of FIG. 3 multiple rectangular strips 12a of felt are wrapped around and affixed to a flexible shaft 11a to form a segmented sheath. The felted shaft is then inserted inside a tubular casing 13a to form the felted shaft assembly. The felt can alternately be affixed to the casing 13a to achieve a similar damping effect. The sheath segments can be spaced evenly or offset from the nodes of longitudinal vibration of the shaft 11a.

Instead of leaving a small clearance space between the sheath and the casing, the sheath may fill the entire space between them; or in the embodiment of FIG. 3, the sheath segments may fill the entire space between the adjacent shaft and casing surfaces.

That is, the assembly may be dimensioned so that there is a small clearance space between an exposed surface of the felt and the adjacent casing surface (if the felt is secured to the shaft) or shaft surface (if the felt is secured to the casing).

With the structure described herein, the flexible shaft 11 or 11a rotates to transmit torque with a close fitting casing 13 or 13a as required by the particular torque transmission application. This assembly transmits or radiates considerably less vibration and noise as compared to prior art flexible shaft assemblies, which do not have a felt interface between the shaft and the casing.

I claim:

1. A wire wound flexible shaft assembly comprising a flexible shaft having an exterior surface surrounded by a coaxial casing having an adjacent interior surface, and a coaxial sheath comprising one or more layers of felt secured to one and only one of said surfaces.

2. The assembly according to claim 1, wherein the felt sheath is segmented and comprises a number of felt strips wrapped around the shaft at spaced intervals.

3. A wire wound flexible shaft assembly comprising:
a torque transmitting flexible shaft;
a coaxial casing surrounding a major portion of the shaft; and
a coaxial sheath comprising felt between the shaft and the casing, the sheath being secured to either the outer surface of the shaft or the inner surface of the casing.

4. The assembly according to claim 3, wherein the felt sheath extends substantially continuously and longitudinally along a major portion of the shaft.

5. The assembly according to claim 3, wherein the sheath is segmented, comprising a series of separate felt sections spaced longitudinally along a major portion of the shaft.

6. The assembly according to claim 5, wherein the sheath segments are positioned in regions offset from the nodes of longitudinal vibration of the shaft.

7. A wire wound flexible shaft assembly comprising:
a torque transmitting flexible shaft;
a coaxial casing surrounding a major portion of the shaft; and
a coaxial sheath between the shaft and the casing, the sheath having a first surface secured to either the outer surface of the shaft or the inner surface of the casing and an opposite second surface, said sheath comprising a material that is soft and compliant and wherein the second surface exhibits low friction with respect to the adjacent surface of the shaft or casing.

8. The assembly according to claim 7, wherein the sheath comprises velour.

9. The assembly according to claim 7, wherein the sheath comprises velvet.

10. The assembly according to claim 7, wherein the sheath comprises acrylic felt.
